(19) United States
(12) Patent Application Publication
(10) Pub. No.: US 2016/0092347 A1
(43) Pub. Date: Mar. 31, 2016

(54) MEDICAL SYSTEM TEST SCRIPT BUILDER

(71) Applicant: CERNER INNOVATION, INC., Kansas City, KS (US)

(72) Inventors: ANTHONY DEVERE EDWARDS, KANSAS CITY, MO (US); MICHAEL ROUBICEK TURMAN, KANSAS CITY, MO (US); DAVID BENJAMIN HAMILTON, KANSAS CITY, MO (US)

(21) Appl. No.: 14/499,878

(22) Filed: Sep. 29, 2014

(51) Int. Cl. G06F 11/36; G06F 19/00

(52) U.S. Cl. CPC G06F 11/3684; G06F 19/3412; G06F 11/3664

(57) ABSTRACT

Computerized systems and methods facilitate the generation of customized test scripts for testing customized healthcare information technology systems. A number of different test script templates may be provided that each corresponds with a different scenario of use of the healthcare information technology system. A user may select a test script template and modify the test script template to generate a customized test script to meet the unique design and/or patient scenarios for a given installation of a healthcare information technology system. The test script template modification process may include first presenting an outline of the test script template, which the user may choose to modify. A detailed view of the test script template may then be provided that allows the user to view and customize actions and expected results in order to generate the customized test script.

### BACKGROUND

Given the complexity of today's healthcare environments, a number of healthcare information technology systems have been developed to assist healthcare providers in managing aspects of delivering healthcare services to patients. The healthcare information technology systems are typically complex in themselves as well. For instance, a healthcare information technology system provided by a vendor may include a number of different solutions. Each solution may be directed to a different aspect of healthcare management (e.g., scheduling, patient registration, medication ordering and administration, pharmacy, charting, etc.). Additionally, each solution may be highly configurable to meet each healthcare provider's individual needs.

Typically, when a healthcare provider purchases a healthcare information technology system from a vendor, various healthcare information technology solutions are selected and tailored to the needs of that healthcare provider. A number of different variables, settings, permissions, etc. may be configured for the healthcare provider. Once the healthcare information technology system has been tailored by the vendor for the healthcare provider, various aspects of the system are typically tested to ensure they perform in the way they are expected to perform.

### BRIEF SUMMARY

Embodiments of the present invention generally relate to generating customized test scripts for testing a customized healthcare information technology system. A test script system provides a number of available test script templates. Each test script template includes a series of actions that are considered standard actions to perform to test a particular scenario of use of the healthcare information technology system. A user may select a test script template for a particular scenario and modify the test script such that it is customized to properly test the unique design and/or patient scenarios of a customized healthcare information technology system. In some instances, a user may initially modify a test script template by viewing a high level outline of the test script template to modify basic information, such as clinician positions involved and high level tasks to be performed. A user may also obtain a detailed view of the test script template that provides details of each action (e.g., a task may include several actions) and expected results when each action is performed. If the user made modifications to the outline, the detailed view of the test script template reflects those modifications. The user may make further modifications to the test script template in the detailed view to generate a customized test script. Accordingly, as will be described in further detail herein, the test script system provides a number of features that increase user efficiencies in creating test scripts. This further allows for improved testing of customized healthcare information technology systems, thereby improving the functioning of the customized systems themselves.

Accordingly, in one aspect, an embodiment of the present invention is directed to one or more computer storage media storing computer-useable instructions that, when used by one or more computing devices, cause the one or more computing devices to perform operations. The operations include providing a list of available test script templates, each test script template including a plurality of actions to be performed to test a corresponding scenario for a customized healthcare information technology system. The operations also include receiving a user selection of a test script template from the list of available test script templates, the test script template corresponding with a particular scenario. The operations further include providing a user interface showing an outline of the test script template including one or more clinician positions involved in the particular scenario and one or more tasks to be performed by each clinician position. The operations still further include receiving one or more first user modification to at least one of the one or more clinician positions and/or the one or more tasks in the outline of the test script template and modifying the outline of the test script template based on the one or more first user modifications. The operations also include providing a user interface including a detailed view of the test script template, the detailed view including the plurality of actions and corresponding expected results for each of the actions, the test script template reflecting the one or more first user modifications to the outline of the test script template. The operations still further include receiving one or more second user modifications to at least one of the one or more actions and/or corresponding expected results and modifying the test script template to generate a customized test script template based on the one or more second user modifications.

In another embodiment, an aspect is directed to a computer-implemented method in a clinical computing environment. The method includes receiving, via a first computing process, a selection of a test script template from a plurality of available test script templates, the test script template corresponding with a particular scenario of use of a customized healthcare information technology system. The method also includes providing, via a second computing process, a detailed view of the test script template including a plurality of actions to take to test the particular scenario of use of the customized healthcare information technology system. The method further includes receiving, via a third computing process, one or more user modifications to the test script template. The method still further includes generating, via a fourth computing process, a customized test script based on the one or more user modifications to the test script template. The first, second, third, and fourth computing processes are performed by one or more computing devices.

A further embodiment is directed to a system comprising: one or more processors; and one or more computer storage media storing instructions that, when used by the one or more processors, cause the one or more processors to: providing a plurality of available test script templates, each test script template identifying a plurality of actions to be performed to test a corresponding scenario for a customized healthcare information technology system; receive a user selection of a test script template from the available test script templates, the test script template corresponding with a particular scenario; provide a user interface showing an outline of the test script template; receive one or more first user modification to the outline of the test script template; modify the outline of the test script template based on the one or more first user modifications; provide a user interface including a detailed view of the test script template, the detailed view including the plurality of actions, the detailed view of the test script template reflecting the one or more first user modifications to the outline of the test script template; receive one or more second user modifications to the one or more actions; and modify the test script template to generate a customized test script template based on the one or more second user modifications.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIG. 2 is a flow diagram showing a method for customizing a test script for testing a healthcare information technology system in accordance with an embodiment of the present invention;

FIG. 3 is a screenshot showing an exemplary test script template user interface for viewing and selecting test script templates in accordance with an embodiment of the present invention;

FIG. 4 is a screenshot showing selection of a particular test script template for customization in accordance with an embodiment of the present invention;

FIGS. 5A-5B are screenshots showing a test script outline UI for viewing and modifying a test script template outline in accordance with an embodiment of the present invention;

FIGS. 6A-6E are screenshots showing a test script customization UI for viewing details of a test script template and customizing the test script template in accordance with an embodiment of the present invention;

FIG. 7 is a screenshot showing a test script manager UI for managing customized test scripts for a testing project in accordance with an embodiment of the present invention; and

FIG. 8 is a screenshot showing an exported version of a customized test script in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Testing healthcare information technology systems configured for healthcare providers is important to ensure the systems perform as intended. To effectively test such healthcare information technology systems, the individuals performing the testing have to be very knowledgeable about the systems and the various solutions making up the system. The testing often takes a lot of time and resources.

One approach for testing healthcare information technology systems is to create test scripts. As used herein, a “test script” outlines a series of actions or steps that are performed using a configured healthcare information technology system and expected results for each step or groups of steps. A number of test scripts can be generated and used to test a healthcare information technology system. However, if the test scripts are not carefully crafted, they may not adequately test the system. For instance, test scripts may be too generic such that they don't do a very good job of accurately and thoroughly testing aspects of the system. Also, generic test scripts may not truly test real clinical workflows that would occur using the system. The result in using such generic test scripts and not adequately testing a configured system is that after the system is implemented at the healthcare provider, gaps in the system may be found (e.g., specific functions don't work at all or don't work as intended, certain users or types of users don't have the ability to perform actions, etc.).

Embodiments of the present invention are generally directed to computerized methods and systems that provide for generating robust test scripts for testing healthcare information technology systems that have been customized for implementation at healthcare providers' facilities. The test script system in accordance with embodiments of the present invention may initially provide a number of test script templates. As used herein, a “test script template” is an initial test script with a series of standard actions or steps and corresponding expected results for a particular scenario. A “scenario” corresponds with a particular way a healthcare information technology system is planned to be used to perform a particular function (e.g., registering a patient, scheduling an appointment, moving an appointment, ordering a medication, administering a medication, etc.). A test script template can be provided for any type of scenario that may be performed using the healthcare information technology system. In some instances, a test script template may correspond with a specific solution within the healthcare information technology system and may include steps that may be performed using that solution.

A user may employ the test script system to customize test script templates to create robust test scripts that are specific for testing a particular implementation of a configured healthcare information technology system. In some embodiments, a user interface (UI) is provided that lists available test script templates. The user may select a test script template for a particular scenario to generate a customized test script for that scenario. By providing a number of test script templates selectable by the user, user efficiency is improved as the user is not required to generate a test script from scratch. Additionally, the test script templates may be designed to employ best known practices for each scenario to properly test a healthcare information technology system.

After selecting a test script template, in some embodiments, an outline of the test script template may initially be provided that shows high level aspects of the test script template. The aspects may include positions (i.e., the types of clinicians) and tasks to be performed for each position. A UI may be provided that allows the user to modify the positions and tasks. Providing the test script outline and allowing users to make changes to the outline increase user efficiency as the outline presents less information so the user is not overwhelmed by too much information as may be the case if the user were to view a detailed view of the test script immediately. Additionally, the user may make high-level modifications to the outline. This may be much more efficient that requiring the user to enter the details of the test script template and make changes to the various details. For instance, to make the same changes made by one modification in the outline, the user may have to make multiple modifications in the detailed view.

Regardless of whether a test script template outline is provided and/or a user makes changes to the outline, a UI is provided that allows the user to view and customize each action or step of the test script template to generate a customized test script. The UI may allow the user to add, remove, or modify actions listed in the test script template. Additionally, the test script template may include expected results for each action, and the user may add, remove, or modify the expected results. Actions and/or expected results may be modified by changing the text. In some embodiments, certain actions and/or expected results may include variables that require the user to enter information that is specific to testing a particular healthcare information technology system. As will be described in further detail herein, the user may enter information into the variables to further modify the test script template and create a customized test script. The variables provided by embodiments herein further increase user efficiency in a number of ways. The variables may be displayed differently allowing a user to quickly identify where information needs to be entered. Additionally, entered information for a variably may be stored by the system such that the entered information may be employed for other variables in the test script template that are of the same variable type. As such, the user is not required to repeatedly enter the same information.

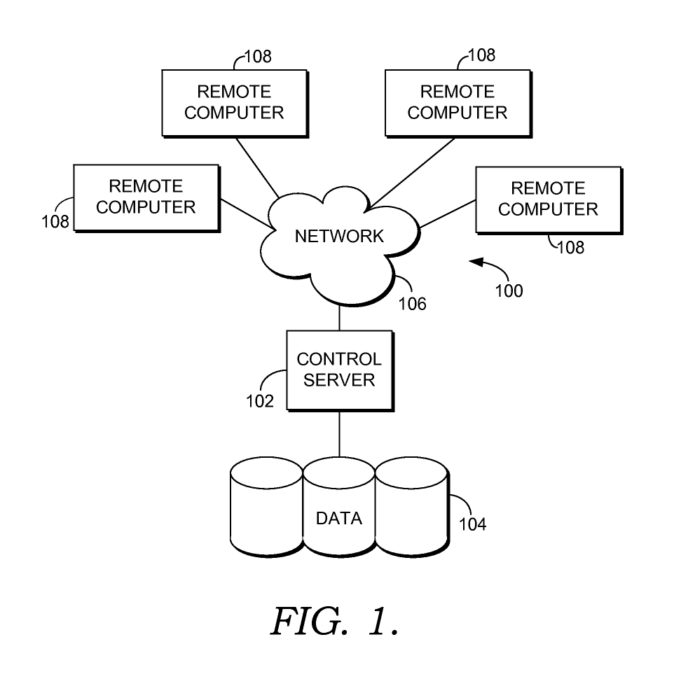

Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media, for instance, database cluster 104. Computer readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Computer storage media does not comprise signals per se. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 104, provide storage of computer readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, office assistants and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

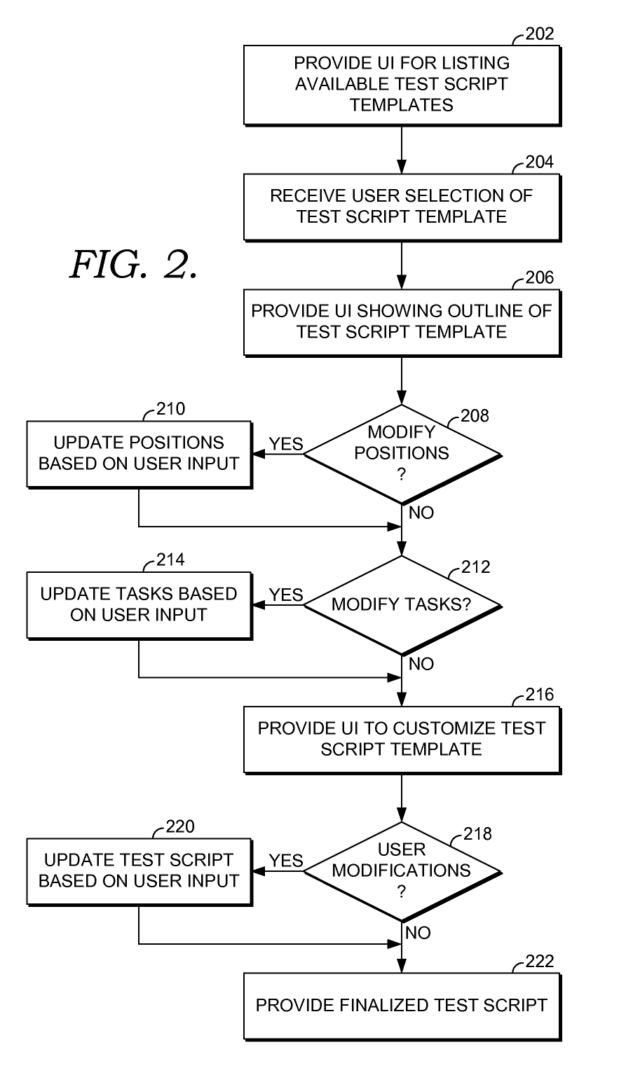

Referring now to FIG. 2, a flow diagram is provided that illustrates a method 200 for generating a customized test script in accordance with an embodiment of the present invention. Initially, as shown at block 202, a user interface (UI) is provided that lists available test script templates. Each test script template corresponds with a particular scenario that may be performed using a healthcare information technology system. One or more test script templates may be provided for each particular scenario. Additionally, each test script may correspond with a particular healthcare information technology solution (i.e., individual application within an overall healthcare information technology system). In some instances, a test script template may include actions in several different healthcare information technology solutions.

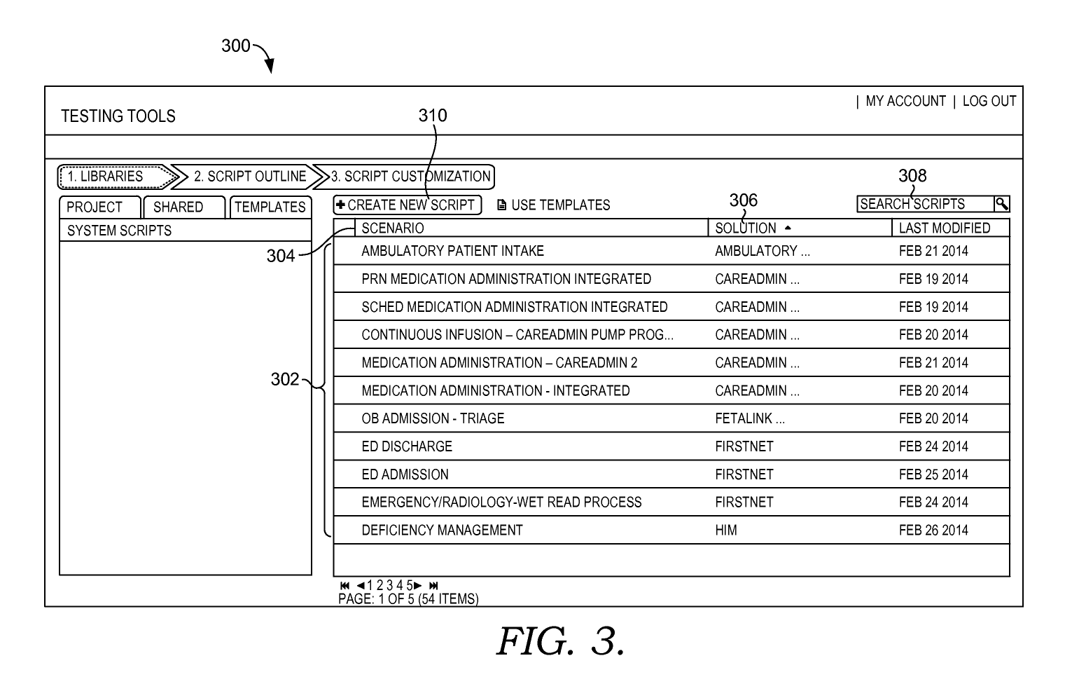

FIG. 3 provides a screenshot of a UI 300 listing available test script templates 302. As shown in FIG. 3, each test script template corresponds with a particular scenario 304. Additionally, the healthcare information technology solution 306 that is tested is identified for each test script template. Further information that may be provided for each test script template may include a date the test script template was last modified and/or a user who modified the test script template. A user may browse the test script templates or may use a search box 308 to search for a particular test script template. The test script templates may be searched by scenario, solution, and/or other information associated with each text script template. As also shown in FIG. 3, the user is given the option 310 to create a new text script. In particular, a test script template may not be available for a scenario the user wishes to test. As such, the user may select the option to create a new text script if desired.

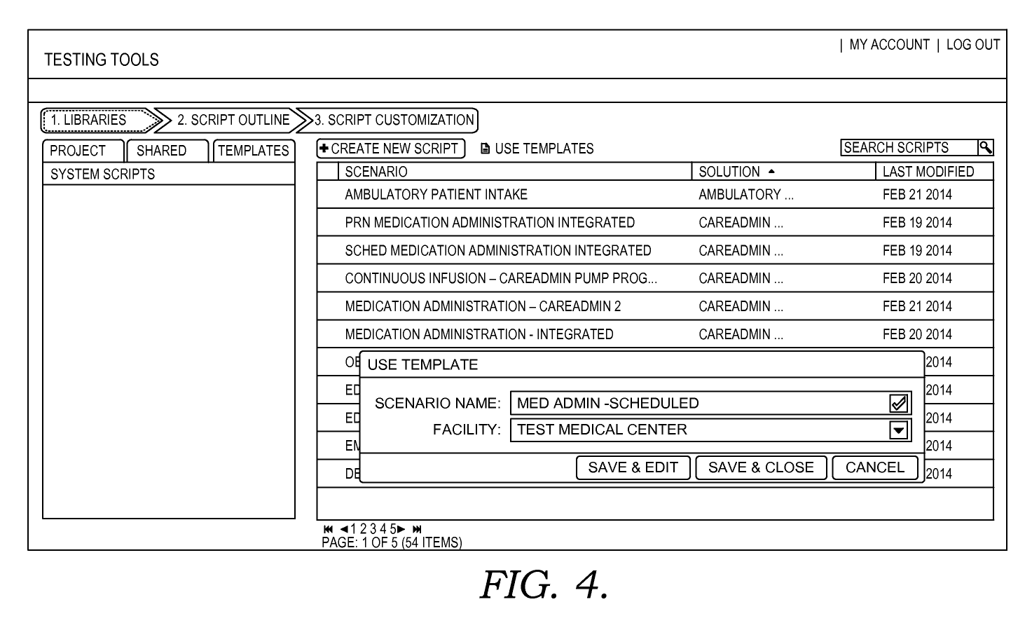

Returning to FIG. 2, a user may select a particular test script template to customize such that a user selection of a particular text script template is received by the system, as shown at block 204. In some embodiments, before a user selects a particular test script template to customize, the user may choose to view a preview of the test script template to make sure that is the test script template the user wishes to use. By way of example to illustrate selection of a test script template for customization, FIG. 4 shows that the user has selected a test script template associated with the scenario named “Med Admin—Scheduled.” This scenario corresponds with actions that are taken for the scheduled administration of a medication. As shown in FIG. 4, the user may associate the customization of the selected test script template with a particular facility. For instance, a healthcare provider may have a number of different facilities within its healthcare system and may wish to have customized solutions that vary for the different facilities.

With reference again to FIG. 2, after a user selects a particular test script template, a UI showing an outline of the selected test script template is provided, as shown at block 206. The outline provides a high level overview of the scenario. This may include a list of positions (i.e., clinician roles) that are involved in the scenario and may also include high-level tasks that are performed by each position. Each task is high-level in the sense that it corresponds with particular actions or steps that are actually performed using the healthcare information technology system. The particular actions or steps may not be shown in the outline view such that the user is not initially overwhelmed with too much information.

In some embodiments, the user is given the capability to modify the positions and/or tasks using the outline. For instance, the user may add, remove, or change positions that are involved in the scenario. The user may also add, remove, or change tasks performed for each position. As such, as shown in FIG. 2, a determination is made at block 208 whether any position modifications have been received from the user. If so, the positions are updated on the outline UI, as shown at block 210. Additionally, a determination is made at block 212 whether any task modifications have been received from the user. If so, the tasks are updated on the outline UI, as shown at block 214.

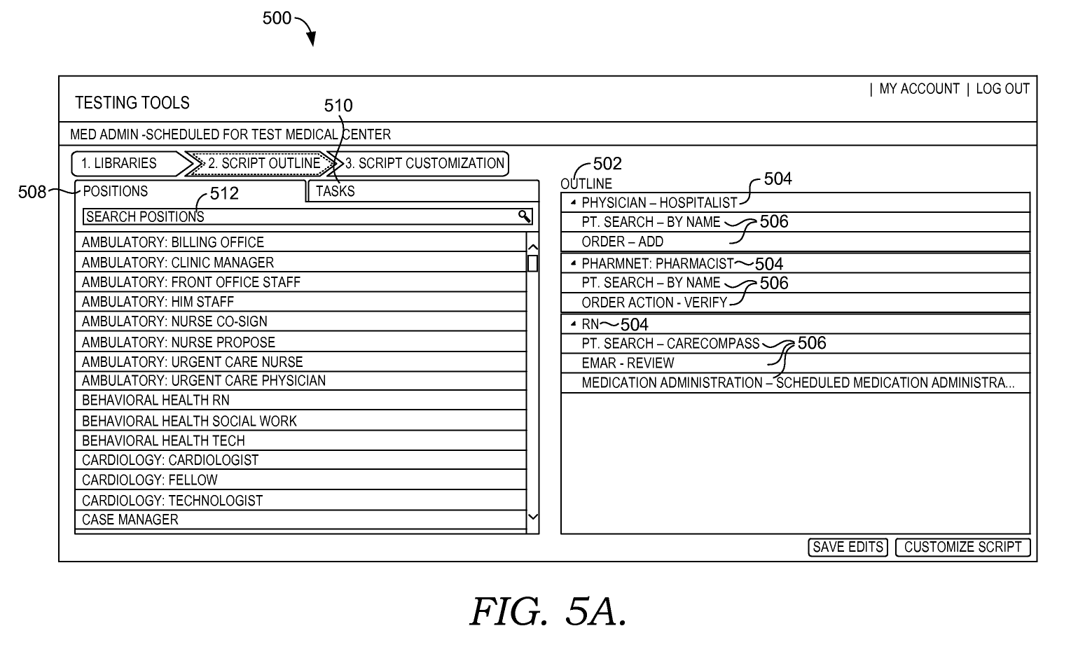

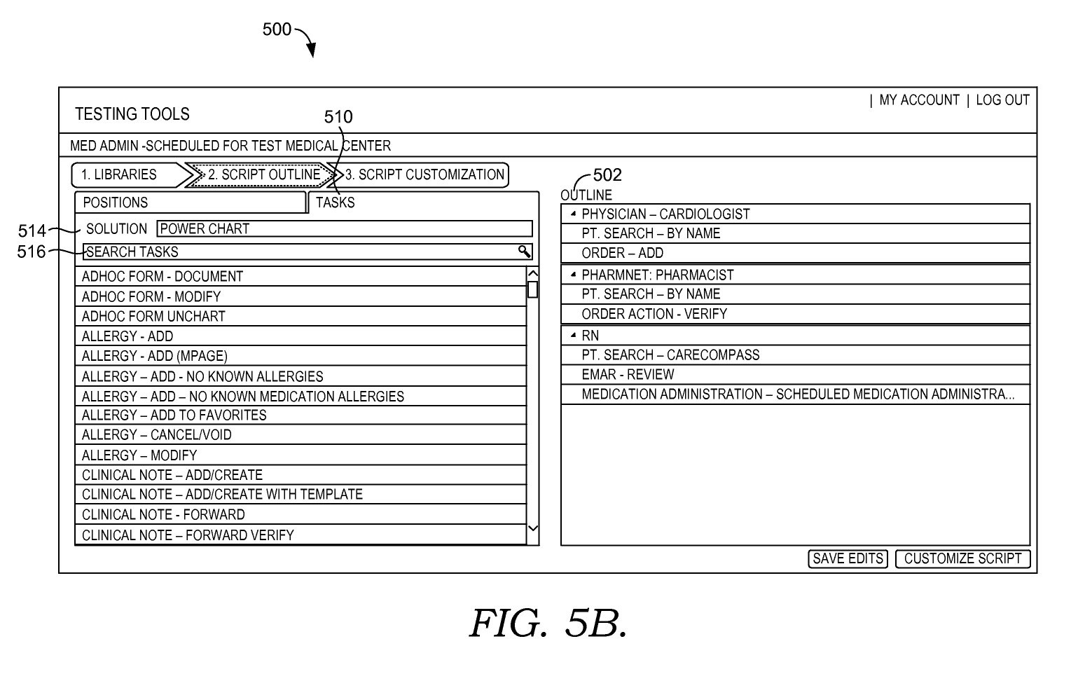

FIG. 5A provides an example screenshot of an outline UI 500 for the “Med Admin—Scheduled” scenario selected in FIG. 4. As shown in FIG. 5A, the outline UI 500 includes an outline area 502. The outline area 502 provides a test script outline that identifies positions 504 involved in the scenario of the test script template and tasks 506 for each position. The outline UI 500 also includes a positions tab 508 and tasks tab 510 that facilitate modifying the positions and tasks in the test script outline. The screenshot of FIG. 5A shows the positions tab 508 selected, providing a list of available positions. A search box 512 is also provided to allow the user to search for a specific position. The user may select a position from the positions tab 508 to add or modify a position in the test script outline. For instance, a user may drag a selected position from the positions tab 508 and drop the selected position on a position in the test script outline in the outline area 502 to change a position in the outline.

FIG. 5B illustrates the outline UI 500 with the tasks tab 510 selected. The tasks tab 510 includes a list of tasks. In some embodiments, tasks may be listed on a per-solution basis. For instance, FIG. 5B includes a UI element 514 for selecting a solution. In the present example, the tasks listed are ones that are available in the “PowerChart” solution. Other tasks may be found by selecting a different solution using the UI element 514. Additionally, a search box 516 is provided for searching for a particular task. The user may select a task from the tasks tab 510 to add or modify a task in the test script outline. For instance, a user may drag a selected task from the tasks tab 510 and drop the selected task on a task in the test script outline in the outline area 502 to change a task in the outline.

Turning back to FIG. 2, after a user views and/or modifies the test script outline, a test script customization UI is provided that allows the user to view and customize the test script template in more detail, as shown at block 216. It should be noted that in some embodiments, a test script outline may not be provided and the test script customization UI may be provided directly in response to the user selecting a test script template at block 204. The test script customization UI provides specific details of the test script, including each action or step of the test script and expected results. The user can make specific changes to each action and/or expected result to customize the test script. Accordingly, as shown at block 218, it is determined whether any user modifications to the test script are received. If so, the test script is updated based on the user input, as shown at block 220. Any of a number of different user modifications may be made to the test script, as will be described in further detail below. Ultimately, the customized test script is finalized, as shown at block 222.

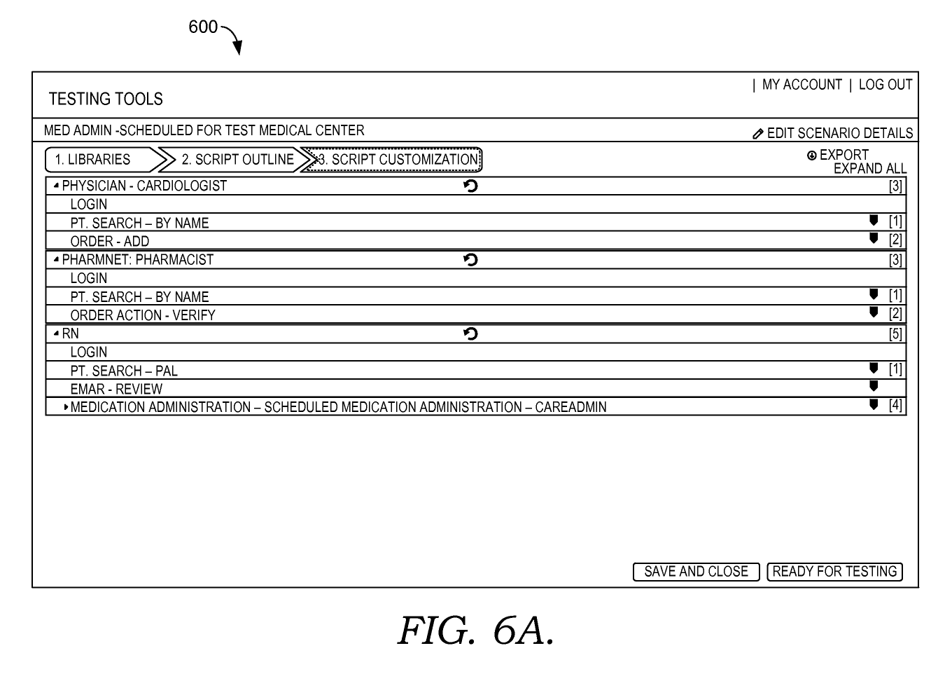

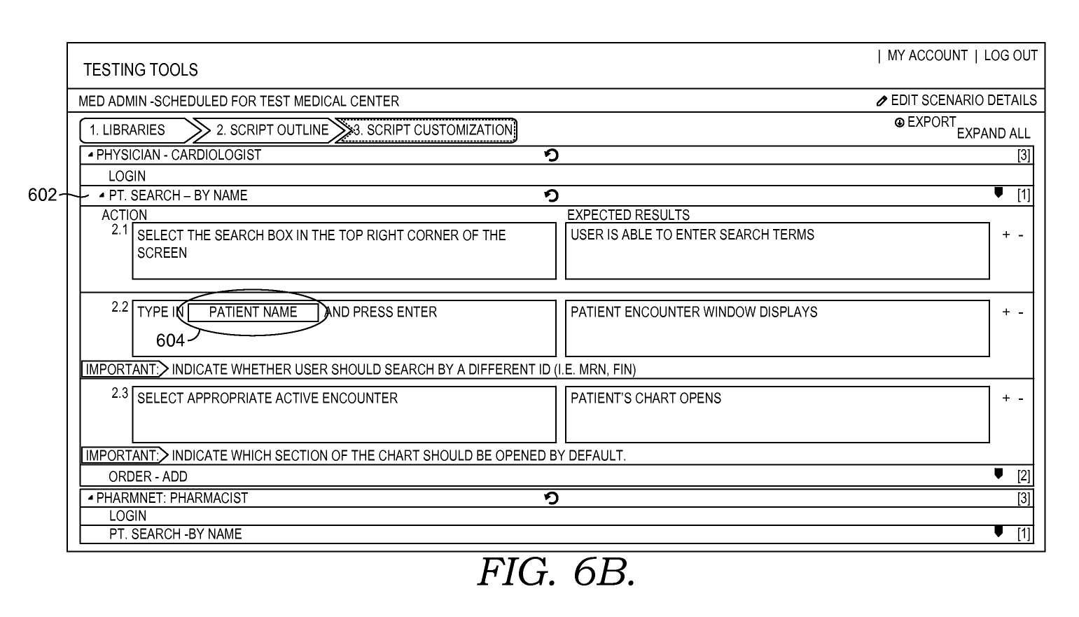

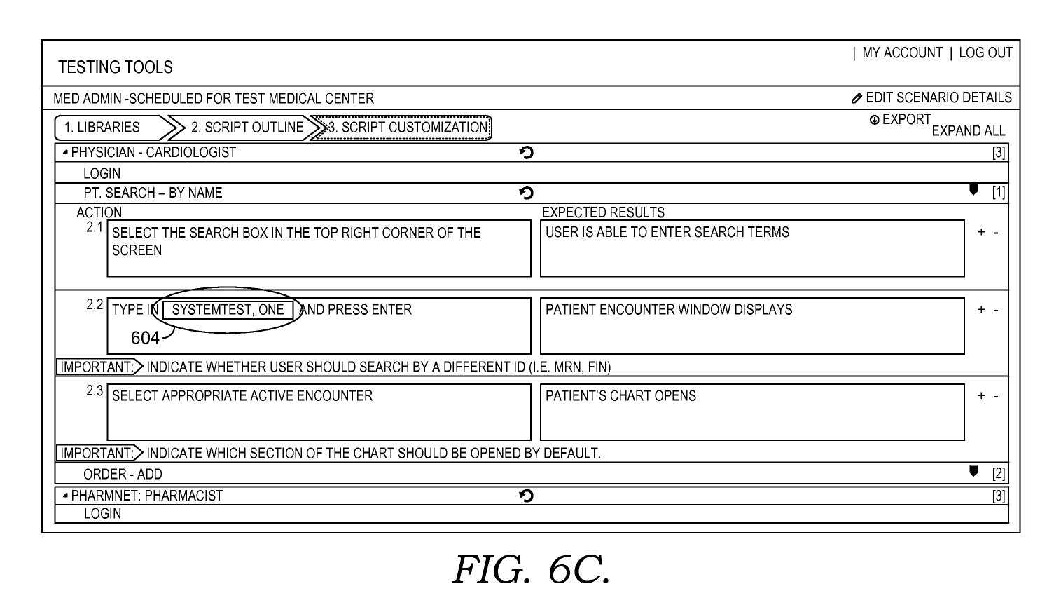

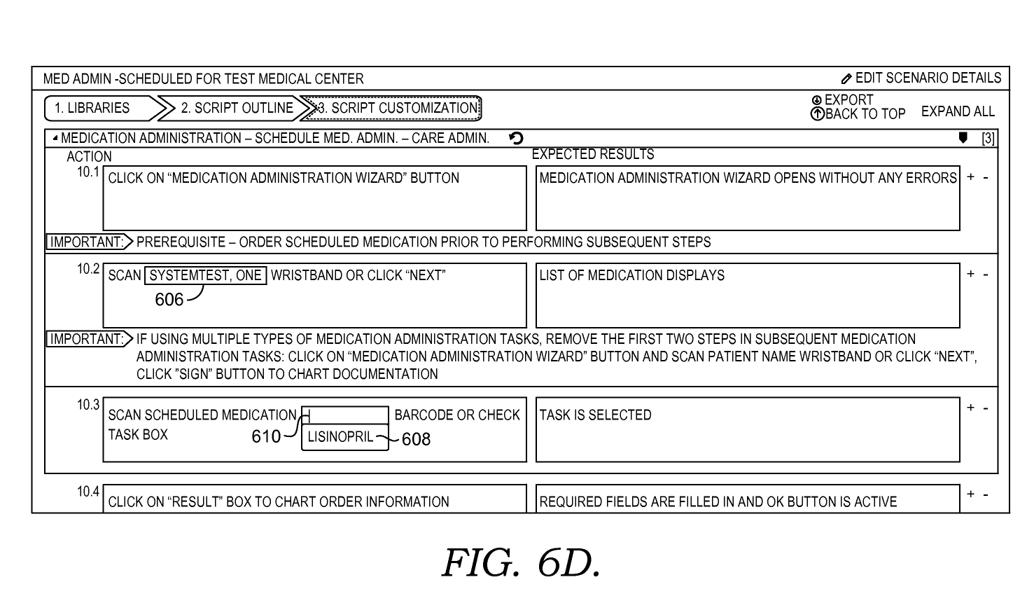

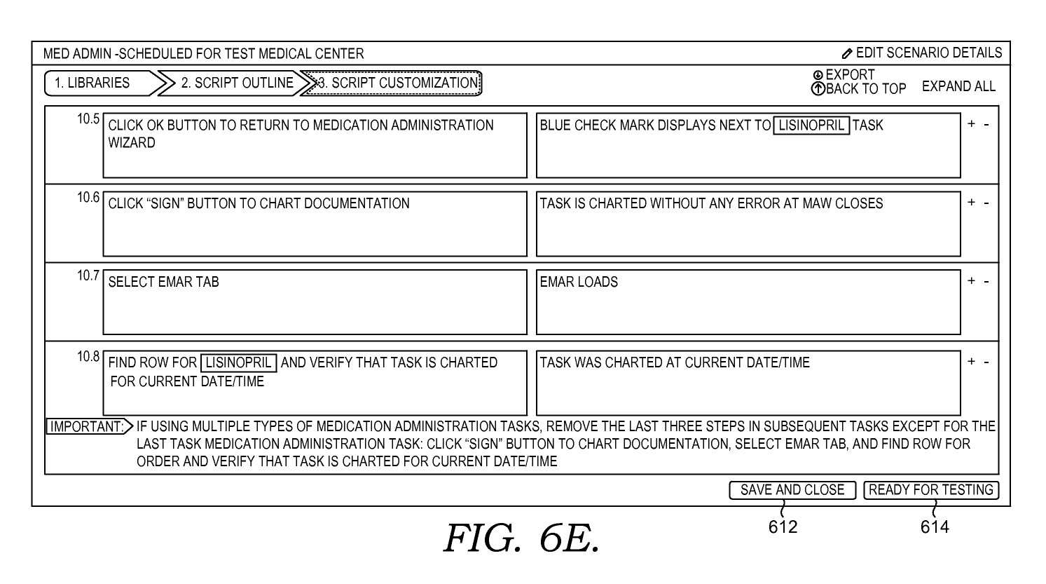

By way of example, FIG. 6A illustrates a screen shot of a test script customization UI 600 that is provided for the “Med Admin—Scheduled” scenario previously provided as an example. In the present example, the test script customization UI 600 may identify the positions and tasks similar to the outline discussed above. However, each task may have a number of actions or steps. A number on the right-hand side of the UI 600 identifies the number of variable for each task (as will be discussed in further detail below). A user may select to view more detailed information for the tasks by selecting a particular task or selecting to expand all tasks. Any modifications made to the test script template outline are reflected in the detailed view of the test script template as well.

FIG. 6B illustrates the test script customization UI 600 with the “Pt. Search—By Name” task 602 expanded. As shown in FIG. 6B, the task 602 includes three actions and corresponding expected results. Text for each action describes the action a user performing the script is to take using the healthcare information technology system, and the text for each expected results describes the results that are expected from the healthcare information technology system in response to the action taken.

A user may modify the test script template using the test script customization UI 600 in a number of ways. For instance, the user may simply edit the text for any selected action or expected results. The user may also delete actions (and their corresponding expected results) and/or the user may add new actions (and corresponding expected results).

In some embodiments, the test script template includes a number of variables. As used herein, a “variable” refers to information that is not standard or common to the template but is specific to the system design for the healthcare provider's implementation and/or information that varies based on how the user wishes to test the selected scenario. In accordance with embodiments of the present invention, a variable is provided in line with the text of an action or expected results and may be identified in the test script customization UI using some visual indicator to draw the user's attention to the variable to indicate to the user that the user needs to address the variable (i.e., provide information). Any visual indicator could be employed, such as an input box, highlighted text, bolded text, etc. The visual indicator may be changed after the user enters information into the variable.

By way of example to illustrate, FIG. 6B includes a variable 604 that is highlighted. In this particular example, the variable prompts the user to enter a specific patient name that would be used to test the system when the customized test script is finalized and used to test the system. FIG. 6C illustrates that the user has entered “Systemtest, One” as the patient name for the variable 604.

In some embodiments, the test script system may automatically populate other variables of the same type with entered information. For instance, in the example above in which the user has entered “Systemtest, One” into a patient name variable, the system may automatically populate other patient name variables in the test script template with “Systemtest, One.” This is illustrated in FIG. 6D in which a variable 606 for another action has been automatically populated with “Systemtest, One.” In other instances, instead of automatically populating other variables of the same type, the test script system may remember previously entered information and provide it as an option for entering when a user encounters another variable of the same type. This may be useful in situations in which different information is desired to be entered into different variables for the same type within a test script template. For instance, if the scenario involves multiple patients, the user may wish to enter different patient names into different patient name variables located at various actions in the test script template. As a specific example to illustrate, FIG. 6D shows a drop down box 608 with “Lisinopril” identified when the user selects a medication variable 610. In particular, the user previously entered “Lisinopril” in a previous medication variable. As such, the test script system now provides that text as an option to complete the current medication variable 610. If the user had previously entered multiple medications in different medication variables in the test script template, the drop down box 608 would list each of those medications. The user may enter text into the variable by simply selecting an option of the drop down box 608.

As shown in the example screenshot of FIG. 6E, a user may choose to save and close a test script at any time by selecting the “Save and Close” button 612. This allows the user to save changes that have been made and then later retrieve the test script for further customization before finalizing the customized test script. As shown in FIG. 6E, a “Ready for Testing” button 614 is also provided that a user can select when done modifying the test script template. This signifies that all changes have been made and a customized test script is now ready that may be employed for testing the healthcare information technology system.

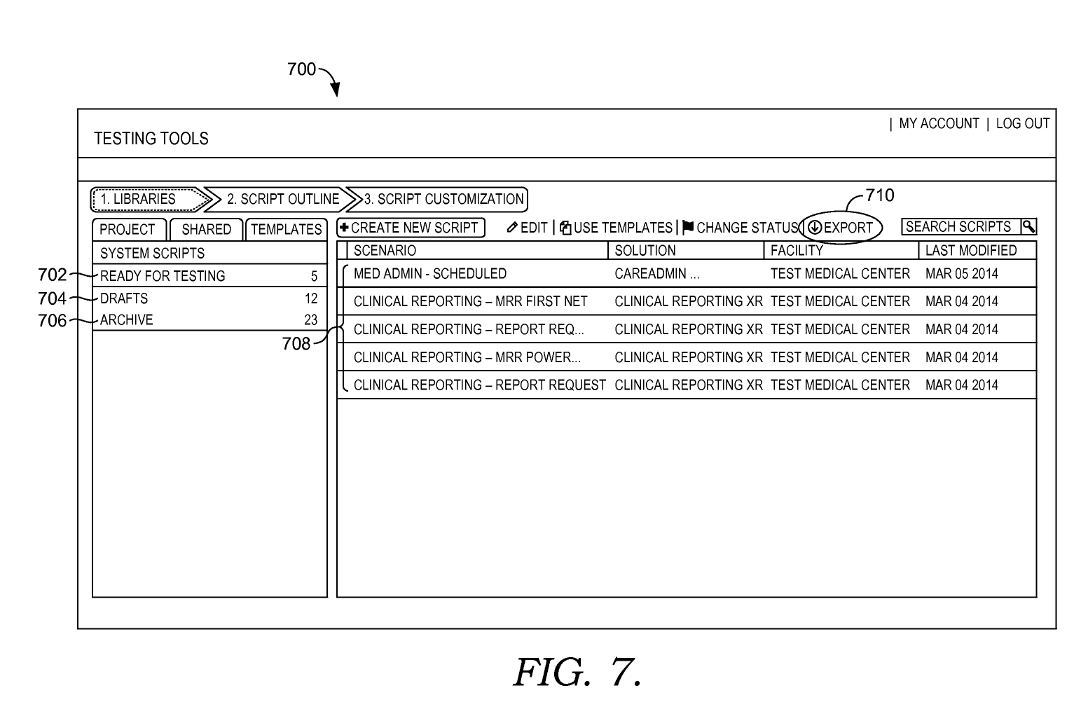

The test script system may further provide a UI for managing test scripts for a testing project to test a particular implementation of a healthcare information technology system. By way of example to illustrate, FIG. 7 provides a screenshot of a test script manager UI 700. As shown in FIG. 7, the test script manager UI 700 identifies test scripts that are ready for testing 702. Additionally, the test script manager UI 700 identifies test script drafts 704. These are test script templates that a user has started to customize but has not yet completed by identifying them ready for testing. As such, the user may retrieve any of those test script drafts to make further modifications as desired and then mark as ready for testing when completed. The test script manager UI 700 further identifies archive test scripts 706. These may be previously customized test scripts.

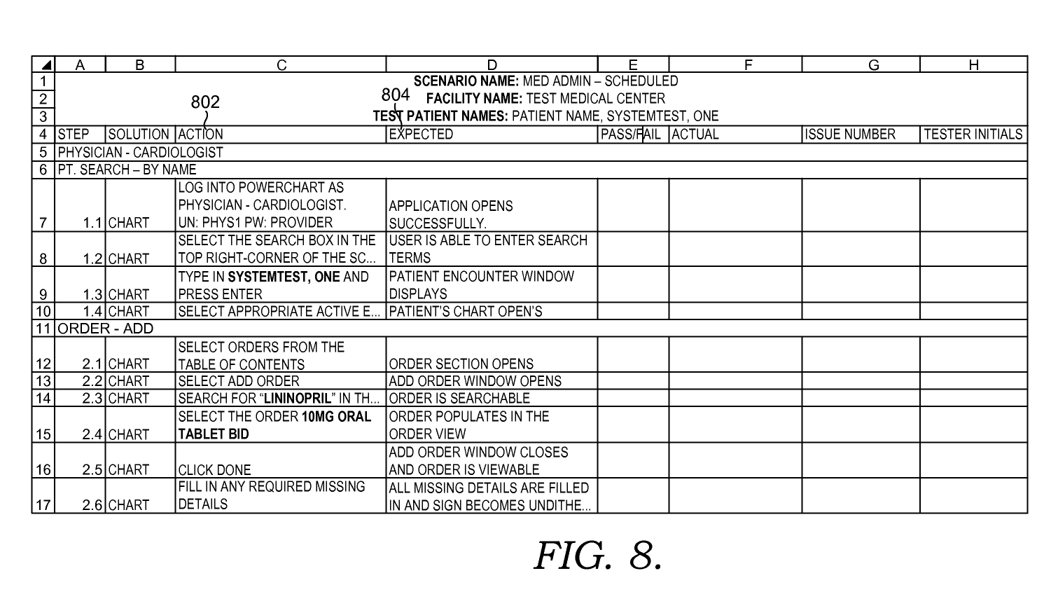

A user may select a particular customized test script that is ready for testing from the list 708 in the test script manager UI 700 and select the export feature 710 to export the customized test script to another format, such as a spreadsheet. FIG. 8 provides an example spreadsheet of a customized test script. As shown in FIG. 8, the exported version of the customized test script identifies, among other things, actions 802 and expected results 804. Additionally, the exported version of the customized test script includes columns for the user to take notes when testing the healthcare information technology system using the customized test script.

As can be understood, embodiments of the present invention provides a system for customizing test scripts for testing customized healthcare information technology systems. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when used by one or more computing devices, cause the one or more computing devices to perform operations comprising:
providing a list of available test script templates, each test script template including a plurality of actions to be performed to test a corresponding scenario for a customized healthcare information technology system;
receiving a user selection of a test script template from the list of available test script templates, the test script template corresponding with a particular scenario;
providing a user interface showing an outline of the test script template including one or more clinician positions involved in the particular scenario and one or more tasks to be performed by each clinician position;
receiving one or more first user modification to at least one of the one or more clinician positions and/or the one or more tasks in the outline of the test script template;
modifying the outline of the test script template based on the one or more first user modifications;
providing a user interface including a detailed view of the test script template, the detailed view including the plurality of actions and corresponding expected results for each of the actions, the test script template reflecting the one or more first user modifications to the outline of the test script template;
receiving one or more second user modifications to at least one of the one or more actions and/or corresponding expected results; and
modifying the test script template to generate a customized test script template based on the one or more second user modifications.

2. The one or more computer storage media of claim 1, wherein the one or more second user modifications includes one or more modifications to text of one or more of the actions.

3. The one or more computer storage media of claim 1, wherein the one or more second user modifications includes one or more modifications to text of one or more of the expected results.

4. The one or more computer storage media of claim 1, wherein the one or more second user modifications includes adding and/or removing an action and a corresponding expected results.

5. The one or more computer storage media of claim 1, wherein the detailed view of the test script template includes one or more variables, each variable comprising a location in-line with text of an action requiring entry of information.

6. The one or more computer storage media of claim 5, wherein the operations further comprise receiving user input providing information for a first variable.

7. The one or more computer storage media of claim 6, wherein the operations further comprise automatically populating one or more other variables of a same variable type as the first variable with the information provided for the first variable.

8. The one or more computer storage media of claim 6, wherein the operations further comprise providing the information provided for the first variable as a user-selectable option for providing user input for one or more other variables of a same variable type as the first variable.

9. A computer-implemented method in a clinical computing environment comprising:
receiving, via a first computing process, a selection of a test script template from a plurality of available test script templates, the test script template corresponding with a particular scenario of use of a customized healthcare information technology system;
providing, via a second computing process, a detailed view of the test script template including a plurality of actions to take to test the particular scenario of use of the customized healthcare information technology system;
receiving, via a third computing process, one or more user modifications to the test script template; and
generating, via a fourth computing process, a customized test script based on the one or more user modifications to the test script template.
wherein the first, second, third, and fourth computing processes are performed by one or more computing devices.

10. The method of claim 9, wherein the method further comprises, prior to providing the detailed view of the test script template:
providing a user interface showing an outline of the test script template including one or more clinician positions involved in the particular scenario and one or more tasks to be performed by each clinician position;
receiving one or more first user modification to the one or more clinician positions and/or the one or more tasks in the outline of the test script template;
modifying the outline of the test script template based on the one or more first user modifications; wherein the detailed view of the test script template incorporates the one or more first user modifications to the outline of the test script template.

11. The method of claim 9, wherein the one or more user modifications to the test script template includes one or more modifications to text of one or more of the plurality of actions.

12. The method of claim 9, wherein the detailed view of the test script template includes an expected result for each of at least a portion of the plurality of actions.

13. The method of claim 12, wherein the one or more user modifications to the test script template includes one or more modifications to text of one or more of the expected results.

14. The method of claim 9, wherein the one or more user modifications to the test script template includes adding and/or removing an action.

15. The method of claim 9, wherein the detailed view of the test script template includes one or more variables, each variable comprising a location in-line with text of an action requiring entry of information.

16. The method of claim 15, wherein the method further comprises receiving user input providing information for a first variable.

17. The method of claim 16, wherein the method further comprises automatically populating one or more other variables of a same variable type as the first variable with the information provided for the first variable.

18. The method of claim 16, wherein the method further comprises providing the information provided for the first variable as a user-selectable option for providing user input for one or more other variables of a same variable type as the first variable.

19. A system comprising:
one or more processors; and
one or more computer storage media storing instructions that, when used by the one or more processors, cause the one or more processors to:
providing a plurality of available test script templates, each test script template identifying actions to be performed to test a corresponding scenario for a customized healthcare information technology system;
receive a user selection of a test script template from the available test script templates, the test script template corresponding with a particular scenario;
provide a user interface showing an outline of the test script template;
receive one or more first user modification to the outline of the test script template;
modify the outline of the test script template based on the one or more first user modifications;
provide a user interface including a detailed view of the test script template, the detailed view including the plurality of actions, the detailed view of the test script template reflecting the one or more first user modifications to the outline of the test script template;
receive one or more second user modifications to the one or more actions; and
modify the test script template to generate a customized test script template based on the one or more second user modifications.

20. The system of claim 19, wherein the one or more second user modifications to the one or more actions are received and the test script template modified to generate the customized test script template based on the one or more second user modifications includes operations to:
present a variable in line with text of an action in the detailed view of the test script;
receive information from the user entered into the variable; and
provide the information for other variables in the detailed view of the test script that are a same variable type as the variable.
